(19) United States
(12) Patent Application Publication
(10) Pub. No.: US 2021/0226991 A1
(43) Pub. Date: Jul. 22, 2021

(54) INFORMATION PROCESSING APPARATUS, INFORMATION PROCESSING SYSTEM, AND RECORDING MEDIUM

(71) Applicant: PANASONIC INTELLECTUAL PROPERTY MANAGEMENT CO., LTD., Osaka (JP)

(72) Inventor: Akihito TAKEUCHI, Osaka (JP)

(73) Assignee: PANASONIC INTELLECTUAL PROPERTY MANAGEMENT CO., LTD., Osaka (JP)

(21) Appl. No.: 17/147,062

(22) Filed: Jan. 12, 2021

(30) Foreign Application Priority Data
Jan. 17, 2020 (JP) 2020-006134

(51) Int. Cl. H04L 29/06

(52) U.S. Cl. CPC H04L 63/1483

(57) ABSTRACT

An information processing apparatus includes an anomaly detector which detects an anomaly in a network based on (i) the number of transmissions of declaration messages containing the same device name to the network or a cumulative time of intervals between the transmissions thereof to the network and (ii) the number of electronic control units connected to the network, and an outputter which outputs a result of detection.

### CROSS REFERENCE TO RELATED APPLICATION

The present application is based on and claims priority of Japanese Patent Application No. 2020-006134 filed on Jan. 17, 2020.

### FIELD

The present disclosure relates to an information processing apparatus, an information processing system, and a recording medium for detecting an anomaly in a network where a plurality of electronic control units (hereinafter, also referred to as ECUs) is connected.

### BACKGROUND

The Society of Automotive Engineers (SAE) J1939 standards are present as a control bus standard applied to moving bodies such as trucks, buses, construction machines, tractors, trailers, or boats and ships. Within a moving body, messages are transmitted and received between ECUs in accordance with the SAE J1939 standards, for example. It is pointed out that there are spoofing attacks to behave like an authorized ECU by transmitting a fraudulent message to a controller area network (CAN), to which the ECU is connected, by malicious use of an address claim (herein, also referred to as ACL) message used in the SAE J1939. To meet this, for example, NPL 1 discloses a technique of detecting an anomaly by malicious use of an ACL message in the SAE J1939 standards. Specifically, authentication and key exchange based on public-key or private-key cryptography are performed between the ECUs, and a fraudulent message can be detected by adding a message authentication code (MAC) to a CAN message packet using the exchanged key.

### CITATION LIST

### Non Patent Literature

NPL 1: Paul-Stefan Murvae et al., “Security shortcomings and countermeasures for the SAE J1939 commercial vehicle bus protocol”, IEEE Transactions on Vehicular Technology, Volume 67, Issue 5, May 2018

### SUMMARY

However, the technique disclosed according to NPL 1 can be improved upon.

In view of this, an information processing apparatus and the like according to one aspect of the present disclosure are capable of improving upon the above related art.

The information processing apparatus according to one aspect of the present disclosure is an information processing apparatus which detects an anomaly in a network to which electronic control units are connected. Each of the electronic control units is a device which transmits a declaration message claiming a source address to use in the network to the network, and starts transmission of a normal message containing the source address to the network. The declaration message contains a device name which is unique to and preliminarily assigned to the device which transmits the declaration message. The information processing apparatus includes an anomaly detector which detects an anomaly in the network based on (i) a number of transmissions of declaration messages containing a same device name to the network or a cumulative time of intervals between the transmissions of the declaration messages containing the same device name to the network and (ii) a number of the electronic control units connected to the network; and an outputter which outputs a result of detection.

The information processing system according to one aspect of the present disclosure includes the information processing apparatus, the electronic control units, and the network.

The recording medium according to one aspect of the present disclosure is a non-transitory computer-readable recording medium for use in an information processing apparatus which detects an anomaly in a network to which electronic control units are connected, the non-transitory computer-readable recording medium having a program recorded thereon for causing the information processing apparatus to execute the program. Each of the electronic control units is a device which transmits a declaration message claiming a source address to use in the network to the network, and starts transmission of a normal message containing the source address to the network. The declaration message contains a device name which is unique to and preliminarily assigned to the device which transmits the declaration message. The program includes detecting an anomaly in the network based on (i) a number of transmissions of declaration messages containing a same device name to the network or a cumulative time of intervals between the transmissions of the declaration messages containing the same device name to the network and (ii) a number of the electronic control units connected to the network; and outputting a result of detection.

The information processing apparatus according to one aspect of the present disclosure is an information processing apparatus which detects an anomaly in a network to which electronic control units are connected. Each of the electronic control units is a device which transmits a declaration message claiming a source address to use in the network to the network, and starts transmission of a normal message containing the source address to the network. The declaration message contains a device name which is unique to and preliminarily assigned to the device which transmits the declaration message. The information processing apparatus is one electronic control unit among the electronic control units, and the information processing apparatus includes an anomaly detector which detects an anomaly in the network based on (i) a number of transmissions of declaration messages containing a same device name to the network or a cumulative time of intervals between the transmissions of the declaration messages containing the same device name to the network and (ii) a number of the electronic control units connected to the network; and an outputter which outputs a result of detection.

The information processing apparatus according to one aspect of the present disclosure can provide a further improvement.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating one example of the information processing system according to an embodiment.

FIG. 2 is a diagram illustrating a format of a data frame used in the SAE J1939 standards.

FIG. 3 is a diagram illustrating a format of the device name assigned to the ECU.

FIG. 4 is a sequence diagram illustrating the rules when the source address to be used is declared through transmission of the declaration message.

FIG. 5A is a sequence diagram illustrating a rule for a competitive source address.

FIG. 5B is a sequence diagram illustrating another rule for a competitive source address.

FIG. 6 is a flowchart illustrating a possibility that the declaration message may be maliciously used.

FIG. 7 is a sequence diagram illustrating one example of the operations of an ECU and an attack ECU when the declaration message is maliciously used.

FIG. 8 is a block diagram illustrating one example of the information processing apparatus according to the embodiment.

FIG. 9 is a flowchart illustrating one example of the operation of the information processing apparatus according to the embodiment.

FIG. 10 is a flowchart illustrating Example 1 of the method of detecting an anomaly in the information processing apparatus according to the embodiment.

FIG. 11 is a diagram illustrating Example 1 of the method of detecting an anomaly in the information processing apparatus according to the embodiment.

FIG. 12 is a flowchart illustrating Example 2 of the method of detecting an anomaly in the information processing apparatus according to the embodiment.

FIG. 13 is a diagram illustrating Example 2 of the method of detecting an anomaly in the information processing apparatus according to the embodiment.

FIG. 14 is a block diagram illustrating one example of the information processing system according to another embodiment.

### DESCRIPTION OF EMBODIMENTS

### Embodiments

The technique disclosed in NPL 1 needs communication for authentication and key exchange, which causes delay due to the communication every time when the CAN communication is started. Moreover, a field as long as 8 bytes is needed to store the MAC within a CAN message packet, thus reducing the data amount transmissible in a single CAN message while increasing the time needed to transmit the message. Thus, when detecting an anomaly in a network such as the CAN, the technique disclosed in NPL 1 may degrade the quality of communication.

Thus, an information processing apparatus and the like which can prevent degradation of communication quality and detect an anomaly in the network will now be described.

### [Configuration of Information Processing System]

The information processing system according to an embodiment will now be described with reference to the drawings.

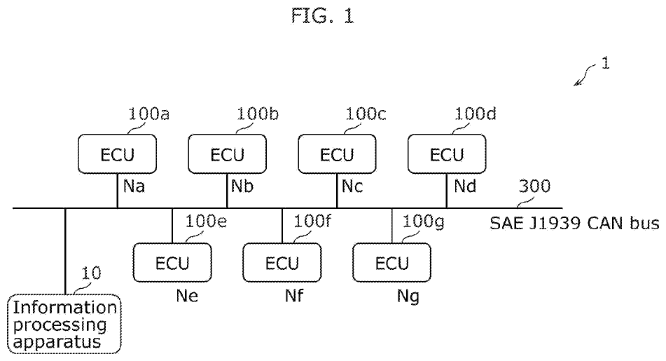

FIG. 1 is a block diagram illustrating one example of information processing system 1 in an embodiment.

Information processing system 1 is a vehicle-installed network, for example. Information processing system 1 includes information processing apparatus 10, a plurality of ECUs, and network 300. Network 300 is a CAN in accordance with the SAE J1939 standards. The ECUs each transmit and receive messages to and from other ECUs via network 300 in accordance with the SAE J1939 standards. For example, in the embodiment, information processing system 1 includes ECUs 100a to 100g as the plurality of ECUs. Focusing on ECU 100a, ECU 100a transmits and receives messages to and from other ECUs 100b to 100g via network 300. In the embodiment, ECUs 100a to 100g connected to network 300 are also collectively referred to as ECU 100. In other words, ECU 100 referred to in the embodiment may be any one of ECUs 100a to 100g. Information processing apparatus 10 is an ECU of one type, and performs transmission and reception of messages with each of ECUs 100 via network 300.

The SAE J1939 standards are a control bus standard applied to moving bodies such as trucks, buses, construction machines, tractors, trailers, or boats and ships. In accordance with the SAE 31939 standards, messages are transmitted and received between the ECUs within such a moving body. In other words, ECU 100 transmits and receives messages via network 300 within the moving body in accordance with the SAE J1939 standards.

Information processing apparatus 10 detects an anomaly in network 300 to which the plurality of ECUs 100 is connected, and is an anomaly detection ECU, for example.

Examples of ECU 100 include, but should not be limited to, a steering control ECU, a steering ECU, an engine ECU, a brake ECU, a door opening/closure sensor ECU, and a window opening/closure sensor ECU.

Information processing apparatus 10 and ECU 100 each include a processor (microprocessor), a memory, and a communication circuit, for example. Examples of the memory include a read only memory (ROM) and a random access memory (RAM). The memory can store programs executed by the processor. For example, when the processor operates according to the programs, information processing apparatus 10 and ECU 100 implement a variety of functions.

From network 300, each of ECUs 100 receives the message transmitted by another ECU 100. Each of ECUs 100 generates a message containing a content to be transmitted to another ECU 100, and transmits the message to network 300. Specifically, each of ECUs 100 performs processing in response to the content of the received message. Each of ECUs 100 generates a normal message containing data indicating the states of devices connected to ECUs 100 or data such as an instruction value (control value), and periodically transmits the normal message to another ECU 100. Moreover, each of ECUs 100 has a unique source address (hereinafter, also referred to as SA) in network 300, and is a device which transmits a declaration message claiming the SA to use in network 300 to network 300, and then starts transmission of a normal message containing the SA to network 300. Specifically, each of ECUs 100 starts transmission of the normal message containing the SA to use in network 300 to network 300 when another ECU 100 does not reply to the transmitted declaration message for a predetermined time (e.g., 250 ms) after the transmission of the declaration message. The declaration message to be transmitted by each of ECUs 100 to network 300 contains a device name (hereinafter, also referred to as DN) which is unique to and preliminarily assigned to ECU 100 which transmits the declaration message. The declaration message will be described later. To be noted, the message containing the data indicating the states of devices or the data such as an instruction value is referred to as normal message to distinguish it from the declaration message. The normal message contains a CANID. Each of ECUs 100 can transmit the normal message to the target ECU 100 because it receives only the message containing a specific CANID.

### [Format]

The format of the CANID and the format of the DN used in the SAE J1939 standards will now be described.

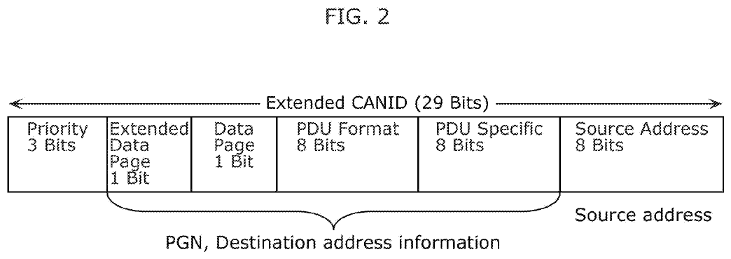

FIG. 2 is a diagram illustrating the format of the CANID used in the SAE J1939 standards. FIG. 2 illustrates the format of a 29-bit extended CANID including the 11-bit standard ID format specified in the CAN protocol as a base and an extension for the control bus applied to moving bodies such as trucks, buses, construction machines, tractors, and trailers. Although the detailed description will be omitted, FIG. 2 shows that the extended CANID contains a field containing a parameter group number (PGN) for identifying the message, destination address information, and the like, and its lower 8 bits are assigned to the SA for specifying the transmission source. After activated, ECU 100 negotiates with other ECUs 100 by transmitting an ACL message, and obtains the SA not competitive with those of other ECUs 100. The ACL message is a message used by the ECU to obtain the SA, and contains the DN assigned to the ECU and the SA to be used by the ECU. While basically the ACL message is transmitted by the ECU at the activation of the ECU, transmission of the ACL message at any timing after activation of the ECU is tolerated in the SAE J1939 standards, for example, supposing a usage case such that an ECU diagnostic tool is connected to the CAN bus after activation of the ECU, and is used. An ECU, which receives the ACL message, can verify that another ECU having the DN contained in the ACL message is about to obtain the SA contained in the ACL message. Details of the method of obtaining the SA by transmitting the ACL message will be described later.

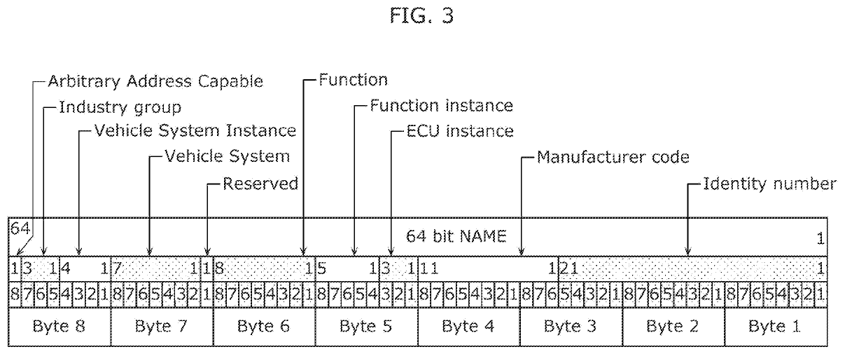

FIG. 3 is a diagram illustrating a format of the DN assigned to the ECU.

As illustrated in FIG. 3, each ECU has a preliminarily assigned 64-bit DN including profile information of the ECU and information for identifying the ECU. Because each ECU should have its unique DN, the DN is assigned to ECU 100 so as not to overlap the DNs of other ECUs irrespective of network 300. In the embodiment, as illustrated in FIG. 1, for example, Na as the DN is assigned to ECU 100a, Nb as the DN to ECU 100b, Nc as the DN to ECU 100c, Nd as the DN to ECU 100d, Ne as the DN to ECU 100e, Nf as the DN to ECU 100f, and Ng as the DN to ECU 100g. On the other hand, if the 64-bit DN is used for every communication between ECUs 100 to specify the transmission source, the amount of transmissible data is reduced by the amount of the DN used (by 64 bits). For this reason, a unique 8-bit SA is used in network 300. The CANID contains an 8-bit SA, and ECU 100, when having received the normal message containing the CANID, can specify the transmission source by checking the SA contained in the CANID.

The present disclosure may be used in applications using other standards than the SAE J1939 standards. For example, the present disclosure can be used in the applied standards of the SAE J1939 standards (such as International Organization for Standardization (ISO) 11783, National Marine Electronics Association (NMEA) 2000, ISO 11992, and Fleet Management System (FMS)).

### [Declaration Message]

Next, the method of wishing use of the SA by ECU 100 in network 300 will be described.

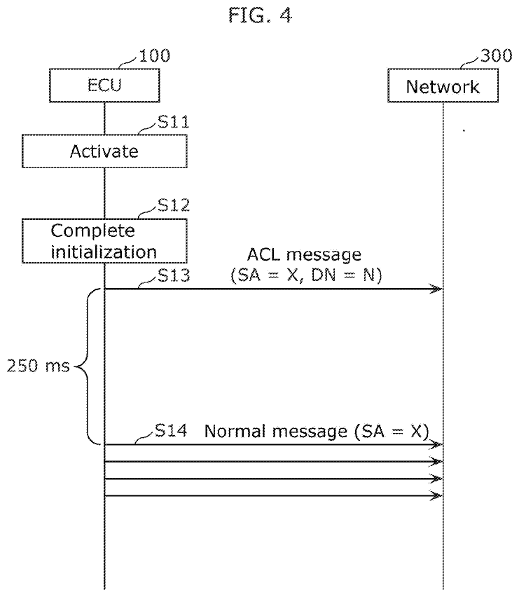

Each of ECUs 100 transmits a declaration message to network 300 for the purpose of using the SA for causing the ECU to be identified by other ECUs 100 in information processing system 1 such that the SA is not competitive with those of other ECUs 100. The declaration message is the ACL message in the SAE J1939 standards. Hereinafter, the rules when the SA to be used is declared through transmission of the ACL message will be described with reference to FIG. 4.

FIG. 4 is a sequence diagram illustrating the rules when the SA to be used is declared through transmission of a declaration message (such as an ACL message).

First, ECU 100 is activated (step S11). After activation, each of ECUs 100 performs an operation to obtain an 8-bit SA which the ECU is about to use.

When initialization is completed (step S12), ECU 100 transmits an ACL message containing an SA to use (for example, here, it is assumed that X is to be used as the SA) and its DN (for example, N) to network 300 (step S13). In other words, ECU 100 broadcasts such an ACL message via network 300 to other ECUs 100, thereby declaring to other ECUs 100 that ECU 100 is about to use X as the SA.

In the SAE J1939 standards, when ECUs 100 have no objection to the ACL message, ECUs 100 each store use of X as the SA by ECU 100 whose assigned DN is N. In contrast, when there is any objection to the ACL message, for example, when the SA is competitive, a rule specifies that a reply to the ACL message should be transmitted within a predetermined time from reception of the ACL message (250 ms in the SAE J1939 standards). For this reason, when ECU 100 does not receive any reply (objection) to its own transmitted ACL message from other ECUs 100 for the predetermined time after the transmission of the ACL message, ECU 100 determines that other ECUs 100 recognize use of X as the SA by ECU 100, and starts transmission (periodic transmission) of a normal message containing the SA to use by ECU 100 to network 300 using the SA (step S14). The normal message contains X as the SA. Thus, by verifying that the SA contained in this message is X, other ECUs 100 can specify the transmission source of the message as ECU 100 whose assigned DN is N.

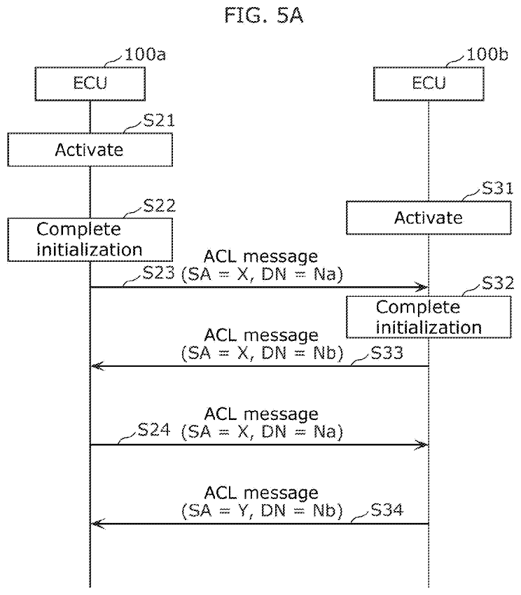

Next, the rule for a competitive SA will be described with reference to FIGS. 5A and 5B.

FIGS. 5A and 5B are sequence diagrams illustrating the rule for a competitive SA. FIG. 5A illustrates one example of the case where the SA is competitive, in which two ECUs 100 competing for the SA resolve the competition and can obtain SAs of their own. FIG. 5B illustrates one example of the case where the SA is competitive, in which one of two ECUs 100 competing for the SA cannot resolve the competition and cannot obtain the SA. With reference to FIGS. 5A and 5B, an example in which ECUs 100a and 100b compete for the SA will be described. Although it seems that ECU 100a and ECU 100b directly communicate with each other in the illustrations of FIGS. 5A and 5B, the communication is actually performed via network 300. In the description below, an expression “the message or the like is transmitted/received between one ECU and the other ECU” is used in some cases. This is because one ECU transmits a message or the like to network 300 and the other ECU receives the message or the like from network 300, and the other ECU transmits a message or the like to network 300 and one ECU receives the message or the like from network 300, and as a result, the message or the like is transmitted/received between one ECU and the other ECU.

First, an example in which two ECUs 100 competing for the SA can obtain the SAs of their own will be described.

As illustrated in FIG. 5A, ECU 100a is activated (step S21), and initialization after the activation is completed (step S22). Then, ECU 100a transmits an ACL message containing its SA to use (herein, for example, X) and its DN Na to ECU 100b (step S23).

ECU 100b is activated after the activation of ECU 100a (step S31), and the ACL message has been transmitted from ECU 100a before initialization is completed. For this reason, ECU 100b cannot receive the ACL message from ECU 100a. As a result, ECU 100a has not received any reply to the transmitted ACL message from other ECUs 100 including ECU 100b. Thus, ECU 100a obtains X as the SA, and starts transmission of a normal message.

After the initialization after the activation is completed (step S32), ECU 100b does not know that ECU 100a was about to obtain X as the SA, and transmits an ACL message including its SA to use (herein, for example, the same SA obtained by ECU 100a, i.e., X) and its DN Nb to ECU 100a (step S33).

SAE J1939 specifies a rule that when ECUs compete for the same SA, an ECU having a smaller value (specifically, a 64-bit integer value) indicated by the DN preferentially obtains the SA. For this reason, it is specified that an ECU having a larger value indicated by the DN gives up obtaining the SA, and again transmits another ACL message containing a reselected different SA. Then, when the ECU cannot obtain the SA (for example, when the ECU cannot obtain any SA although the ECU has transmitted ACL messages for a variety of SAs for a certain period of time in attempts to obtain an SA, or when the ECU cannot obtain the SA even if the ECU has transmitted ACL messages for all SA candidates), the ECU transmits a Cannot Claim message indicating that the ECU cannot obtain the SA, and pauses. The Cannot Claim message is a message containing the DN assigned to the ECU, and a message for notifying other ECUs that the ECU having the assigned DN fails to obtain the SA. The other ECUs, which have received the Cannot Claim message, can verify that the ECU having the assigned DN contained in the Cannot Claim message fails to obtain the SA.

ECU 100a has already obtained X as the SA while ECU 100b has transmitted the ACL message containing X as the SA to use, resulting in competition for the SA. It is assumed that Na as the DN of ECU 100a is smaller than Nb as the DN of ECU 100b. In this case, ECU 100a has priority to ECU 100b for obtaining the SA. Thus, as an objection to the ACL message transmitted by ECU 100b, ECU 100a again transmits an ACL message containing X as the SA and Na as its DN to ECU 100b (step S24).

ECU 100b recognizes that ECU 100a having Na, which is a DN smaller than its own DN Nb, preferentially obtains X as the SA, and transmits another ACL message containing Y as a reselected different SA (step S34). When any reply to the ACL message transmitted by ECU 100b is not transmitted from other ECUs 100 after 250 ms has passed from the transmission of the ACL message, ECU 100b obtains Y as the SA.

It is noted that because initialization of ECU 100b has not been completed and ECU 100b cannot recognize that ECU 100a was about to obtain X as the SA, ECU 100b transmits the ACL message containing X as the SA in step S33. On the other hand, when ECU 100b receives the ACL message containing X as the SA and Na as the DN from ECU 100a after the initialization of ECU 100b, ECU 100b transmits an ACL message containing another SA but not the ACL message X as the SA because ECU 100a has higher priority than ECU 100b.

Next, an example in which one of two ECUs 100 competing the same SA fails to obtain the SA will be described. The processings in steps S21 to S24 and steps S31 to S33 are the same as those in FIG. 5A, and the descriptions thereof will be omitted.

After step S24, ECU 100b recognizes that ECU 100a having Na, which is a DN smaller than its own DN, i.e., Nb, preferentially obtains X as the SA, and tries to obtain a different SA. When ECU 100b fails to obtain the different SA, ECU 100b transmits a Cannot Claim message containing Nb as its own DN, and pauses (step S35). Thereby, other ECUs 100 including ECU 100a recognize that the DN contained in this message is Nb, thereby recognizing that ECU 100b fails to obtain the SA and is at a pause.

### [Malicious Use of Declaration Message]

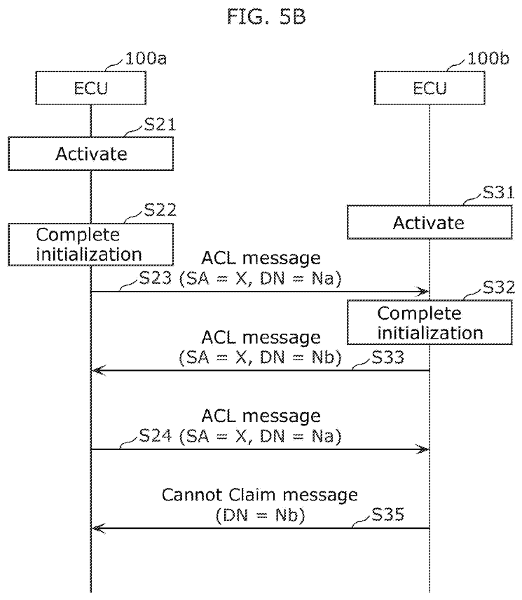

Next, a possibility of malicious use of the declaration message in the SAE J1939 standards will be described with reference to FIG. 6.

FIG. 6 is a flowchart illustrating a possibility of malicious use of a declaration message in the SAE J1939 standards (such as an ACL message). FIG. 6 is a flowchart illustrating the operation of ECU 100 which has already started transmission of a normal message using the SA, which another ECU 100 is about to use, when ECU 100 receives an ACL message from another ECU 100.

ECU 100 receives an ACL message from another ECU 100 (step S101). For example, ECU 100 receives an ACL message from another ECU 100, the ACL message containing the same SA as that used by ECU 100.

ECU 100 compares the value indicated by the DN of its own (also referred to as its own DN) to that indicated by the DN (also referred to as the other DN) contained in the received ACL message, and determines whether the value indicated by its own DN is equal to or greater than the value indicated by the other DN (step S102).

When the value indicated by its own DN is smaller than the value indicated by the other DN (No in step S102), ECU 100, whose priority is higher than that of another ECU 100, transmits an ACL message containing the SA obtained by ECU 100 and its own DN to another ECU 100 without stopping the normal message (step S104). Thereby, another ECU 100 recognizes that it cannot obtain the SA.

In contrast, when the value indicated by its own DN is equal to or greater than the value indicated by the other DN (Yes in step S102), ECU 100, whose priority is lower than that of another ECU 100, stops the transmission of the normal message, and tries to change the SA (step S103). For example, ECU 100 transmits a declaration message containing another SA adjacent to the SA already used to network 300.

Here, as illustrated in step S102, the SAE J1939 standards specifies that when the value indicated by the other DN contained in the received ACL message is smaller than or equal to the value indicated by its own DN, it is determined that another ECU 100 has priority higher than that of ECU 100. For this reason, when ECU 100 receives a fraudulent ACL message containing the same SA as that of ECU 100, such a fraudulent ACL message may cause ECU 100 to stop the transmission of the normal message, and further to change the SA used.

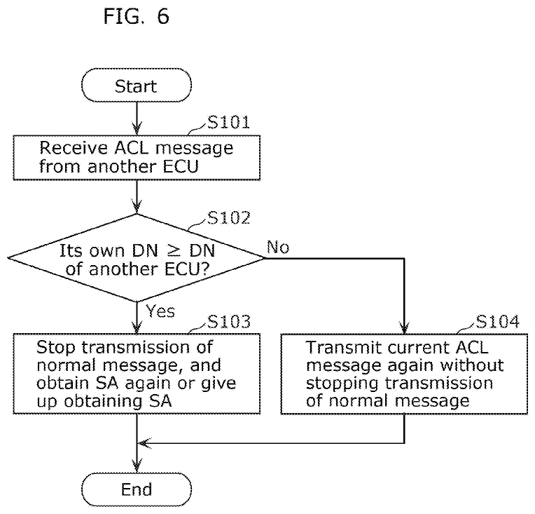

This leads to a concern that malicious use of the ACL message in the SAE J1939 standards may allow attacks by spoofers which pretend to be legitimate ECU 100, for example. Hereinafter, an attack to legitimate ECU 100a, whose DN is Na, by a fraudulent ECU (also referred to as attack ECU 100x) which is connected to network 300 and pretends to be ECU 100a will be described with reference to FIG. 7.

FIG. 7 is a sequence diagram illustrating one example of the operations of ECU 100a and attack ECU 100x when a declaration message (such as an ACL message) is maliciously used.

For example, ECU 100a transmits an ACL message containing Na as the DN and A as the SA to network 300 (step S41). Attack ECU 100x receives the ACL message containing Na as the DN and A as the SA. Attack ECU 100x recognizes that ECU 100x having Na as the DN tries to obtain A as the SA, and transmits an ACL message containing Na as the DN and A as the SA to network 300 to pretend as ECU 100a (step S51).

ECU 100a receives the ACL message containing Na as the DN and A as the SA. Because the value indicated by the other DN contained in the ACL message is the same as the value indicated by its own DN, ECU 100a determines that the priority of the other ECU is higher than that of ECU 100a, and transmits an ACL message containing a different SA (e.g., B) to network 300 (step S42). In response to this, to receive the ACL message containing Na as the DN and B as the SA, attack ECU 100x immediately transmits an ACL message containing Na as the DN and B as the SA to network 300 (step S52). Thereby, attack ECU 100x blocks ECU 100a from obtaining B as the SA.

ECU 100a receives the ACL message containing Na as the DN and B as the SA. Because the value indicated by the other DN contained in the received ACL message is equal to the value indicated by its own DN, ECU 100a determines that the priority of the other ECU is higher than that of ECU 100a, and transmits an ACL message containing a different SA (e.g., C) to network 300 (step S43). In response to this, to receive an ACL message containing Na as the DN and C as the SA, attack ECU 100x immediately transmits an ACL message containing Na as the DN and C as the SA to network 300 (step S53). Thereby, attack ECU 100x blocks ECU 100a from obtaining C as the SA.

As described above, attack ECU 100x continuously blocks ECU 100a from obtaining the SA until ECU 100a gives up obtaining the SA (in other words, until ECU 100a transmits a Cannot Claim message). For example, ECU 100a transmits an ACL message containing Na as the DN and Y as the SA to network 300 (step S44). In response to this, attack ECU 100x transmits an ACL message containing Na as the DN and Y as the SA to network 300 (step S54). ECU 100a then gives up obtaining the SA, and transmits a Cannot Claim message to network 300 (step S45).

Thus, thereafter, attack ECU 100x pretends to be ECU 100a having Na as the DN, and can transmit messages.

In the present disclosure, information processing apparatus 10 which detects an anomaly in network 300 is connected to network 300 to which a plurality of ECUs 100 is connected. Hereinafter, the configuration and the operation of information processing apparatus 10 will be described.

### [Configuration and Operation of Information Processing Apparatus]

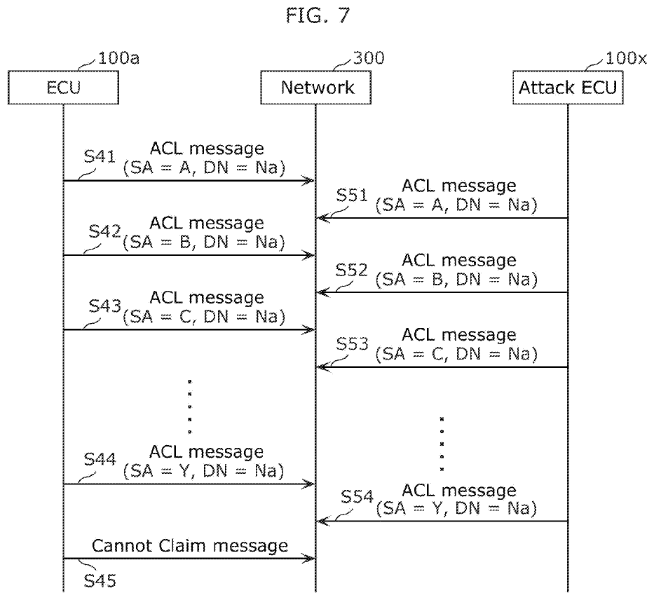

FIG. 8 is a block diagram illustrating one example of information processing apparatus 10 according to the embodiment.

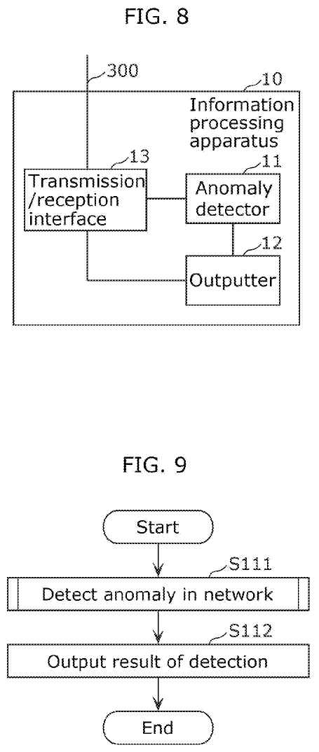

FIG. 9 is a flowchart illustrating one example of the operation of information processing apparatus 10 according to the embodiment.

Information processing apparatus 10 includes anomaly detector 11, outputter 12, and transmission/reception interface 13.

Transmission/reception interface 13 receives messages transmitted to network 300, and transmits messages to network 300. Transmission/reception interface 13 is implemented with a communication circuit or the like included in information processing apparatus 10, for example.

Anomaly detector 11 detects an anomaly in network 300 based on (i) the number of transmissions of the ACL messages containing the same DN to network 300 or the cumulative time of intervals between the transmissions to network 300 and (ii) the number of ECUs 100 connected to network 300 (step S111). Details of step S11, namely, details of anomaly detector 11 will be described later.

Outputter 12 outputs the result of detection by anomaly detector 11 (step S112). For example, outputter 12 outputs the result of detection to ECU 100 via transmission/reception interface 13, or outputs the result of detection to a user of the moving body on which information processing apparatus 10 is mounted or a central management center which manages the moving body. Thereby, information processing apparatus 10 can stop the moving body to ensure safety, or can notify the user that there is an anomaly in network 300.

Anomaly detector 11 and outputter 12 are implemented by operating the processor included in information processing apparatus 10 according to a program stored in a memory.

### [Example 1 of Method of Detecting Anomaly]

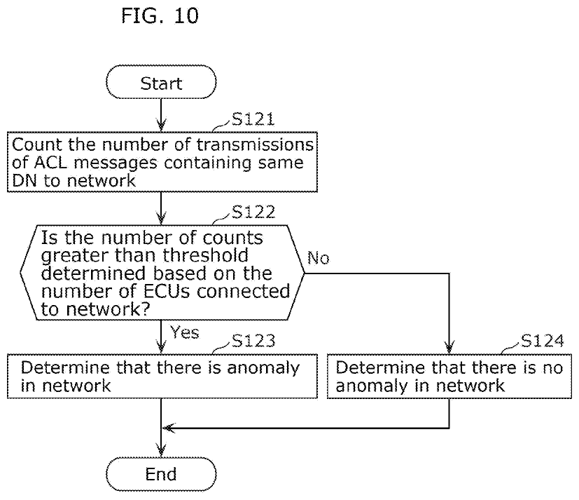

FIG. 10 is a flowchart illustrating Example 1 of the method of detecting an anomaly in information processing apparatus 10 according to the embodiment. FIG. 10 is a flowchart illustrating one example of details of step S112 in FIG. 9.

As illustrated in FIG. 10, anomaly detector 11 counts the number of transmissions of the ACL messages containing the same DN to network 300 (step S121). For example, anomaly detector 11 counts the number of transmissions from the activation of the moving body (specifically, from the activation of information processing apparatus 10 by electricity fed from the activated moving body). For example, anomaly detector 11 checks the DN contained in the received ACL message every time when transmission/reception interface 13 receives the ACL message transmitted to network 300, and counts the number of transmissions of the ACL messages containing the same DN to network 300.

Next, anomaly detector 11 determines whether the number of counts, namely, the number of transmissions of the ACL messages containing the same DN to network 300 is larger than the threshold determined based on the number of ECUs 100 connected to network 300 (step S122).

When anomaly detector 11 determines that the number of transmissions of the ACL messages containing the same DN to network 300 is larger than the threshold determined based on the number of ECUs 100 connected to network 300 (Yes in step S122), anomaly detector 11 determines that there is an anomaly in network 300 (step S123). When anomaly detector 11 determines that the number of transmissions of the ACL messages containing the same DN is less than or equal to the threshold based on the number of ECUs 100 connected to network 300 (No in step S122), anomaly detector 11 determines that there is no anomaly in network 300 (step S124).

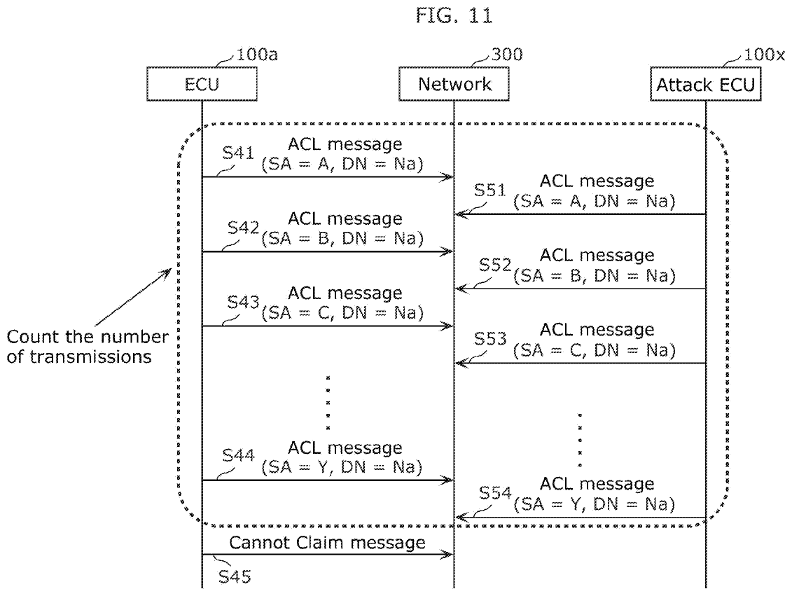

Here, the reason why anomaly detector 11 can determine that there is an anomaly in network 300 when the number of transmissions of the ACL messages containing the same DN is larger than the threshold determined based on the number of ECUs 100 connected to network 300 will be described with reference to FIG. 11.

FIG. 11 is a diagram illustrating Example 1 of the method of detecting an anomaly in information processing apparatus 10 according to the embodiment.

For example, it is assumed that the DN of ECU 100a is greater than those of other ECUs 100b to 100g, in other words, among ECUs 100a to 100g, ECU 100a has the lowest priority to obtain the SA. At this time, examples of the situation in which ECU 100a transmits the largest number of ACL messages during normal operation where there is no anomaly in network 300 include the following situation: ECU 100a transmits an ACL message, resulting in competition with one (for example, ECU 100b) of ECUs 100. ECU 100a transmits another ACL message containing a different SA, resulting in competition with ECU 100 (for example, ECU 100c) which did not compete with ECU 100a. ECU 100a then transmits another ACL message containing a different SA, resulting in competition with ECU 100 (for example, ECU 100d) which did not compete with ECU 100a. ECU 100a then transmits another ACL message containing a different SA, resulting in competition with ECU 100 (for example, ECU 100e) which did not compete with ECU 100a. ECU 100a then transmits another ACL message containing a different SA, resulting in ECU 100 (for example, ECU 100f) which did not compete with ECU 100a. ECU 100a then transmits another ACL message containing a different SA, resulting in competition with ECU 100 (for example, ECU 100g) which did not compete with ECU 100a. Finally, when there is no competitor ECU 100, ECU 100a transmits another ACL message containing a different SA, and successfully obtains the SA. In such a situation, ECU 100a may transmit ACL messages containing the same DN (for example, Na) to network 300 at most 7 times from activation of the moving body. In other words, transmission of ACL messages containing the same DN to network 300 beyond this number of times (here, 7 times) does not occur during normal operation. Thus, the number of times is defined as a threshold, and the threshold is compared with the number of transmissions of the ACL messages containing the same DN. The threshold can be determined based on the number of ECUs 100 connected to network 300, and specifically corresponds to the number of ECUs 100 (here, 7) connected to network 300.

For example, in the case where attack ECU 100x is fraudulently connected to network 300 and tries to pretend to be ECU 100a, ACL messages containing the same DN, i.e., Na are transmitted from ECU 100a and attack ECU 100x, respectively, to network 300. In this case, as illustrated in FIG. 11, attack ECU 100x transmits an ACL message containing the same DN as that of ECU 100a every time when ECU 100a transmits an ACL message. As a result, the ACL messages containing the same DN are transmitted to network 300 beyond the threshold (here, 7 times), which is the maximum number of times of transmissions of such ACL messages during the normal operation.

For this reason, as represented by the dashed-lined frame in FIG. 11, anomaly detector 11 counts the number of transmissions of the ACL messages containing the same DN from the activation of the moving body. When the number of times is greater than the number of ECUs 100 connected to network 300, anomaly detector 11 can determine that there is an anomaly in network 300, and can detect the anomaly in network 300.

For example, the number of ECUs 100 connected to network 300 as the threshold may be preliminarily set by a user or a manager of information processing apparatus 10. Alternatively, information processing apparatus 10 may estimate the number of ECUs 100 connected to network 300 from the number of types of DN contained in the ACL messages transmitted to network 300, and may set the estimated number as the threshold.

The threshold determined based on the number of ECUs 100 connected to network 300 can be determined based on any other number than the number of ECUs 100 connected to network 300.

For example, in the case where another ECU 100 may be additionally connected to network 300 in the future, the threshold including the number of ECUs 100 to be additionally connected may be preliminarily set. In this case, the threshold is the number of ECUs 100 which may be connected to network 300. For example, in the case where seven ECUs 100 are currently connected to network 300 and at most nine ECUs 100 may be connected to network 300, the threshold is 9 times. For example, as the threshold, the number of ECUs 100 which may be connected to network 300 may be preliminarily set by a user or a manager of information processing apparatus 10.

In another case, for example, depending on the specification, a plurality of ECUs 100 connected to network 300 may include ECU 100 whose SA to use is preliminarily determined and set so as not to compete with others ECU 100 when ECU 100 obtains the SA. In this case, the threshold is the number of ECUs 100 obtained by subtracting the number of ECUs 100 set so as not to compete with other ECUs 100 from the number of ECUs 100 connected to network 300. For example, in the case where seven ECUs 100 are currently connected to network 300 and one of ECUs 100 does not compete with others ECU 100, the threshold is 6 times. For example, as the threshold, the number of ECUs 100 obtained by subtracting the number of ECUs 100 set so as not to compete with other ECUs 100 from the number of ECUs 100 connected to network 300 may be preliminarily set by a user or a manager of information processing apparatus 10.

For example, the plurality of ECUs 100 connected to network 300 may include inactive ECUs 100. In this case, the threshold is the number of ECUs 100 obtained by subtracting the number of inactive ECUs 100 from the number of ECUs 100 connected to network 300. For example, in the case where seven ECUs 100 are currently connected to network 300 and one of ECUs 100 is inactive, the threshold is 6 times. For example, as the threshold, the number of ECUs 100 obtained by subtracting the number of inactive ECUs 100 from the number of ECUs 100 connected to network 300 may be preliminarily set by a user or a manager of information processing apparatus 10. Alternatively, from the number of types of DN contained in the ACL messages transmitted to network 300, information processing apparatus 10 may estimate the number of ECUs 100 obtained by subtracting the number of inactive ECUs 100 from the number of ECUs 100 connected to network 300, and may set the estimated number as the threshold.

Thus, in Example 1 of the method of detecting an anomaly, the presence of an anomaly in network 300 can be detected when the number of transmissions of the ACL messages containing the same DN is greater than the threshold determined based on the number of ECUs 100 connected to network 300.

[Example 2 of Method of Detecting Anomaly]

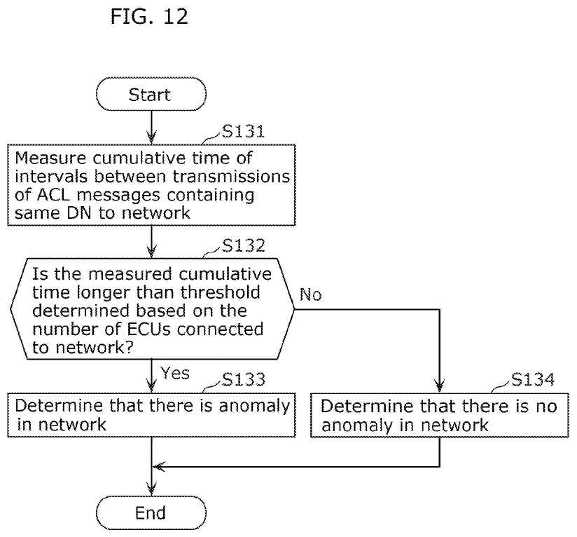

FIG. 12 is a flowchart illustrating Example 2 of the method of detecting an anomaly in information processing apparatus 10 according to the embodiment. FIG. 12 is a flowchart illustrating one example of details of step S112 in FIG. 9.

As illustrated in FIG. 12, anomaly detector 11 measures the cumulative time of the intervals between the transmissions of ACL messages containing the same DN to network 300 (step S131). For example, anomaly detector 11 measures the time from the activation of the moving body (specifically, from the activation of information processing apparatus 10 by electricity fed from the activated moving body). For example, anomaly detector 11 checks the DN contained in the received ACL message every time when transmission/reception interface 13 receives the ACL message transmitted to network 300, and measures the cumulative time of the intervals between the transmissions of the ACL messages containing the same DN to network 300.

Next, anomaly detector 11 determines whether the measured cumulative time, namely, the cumulative time of the intervals between the transmissions of the ACL messages containing the same DN to network 300 is longer than the threshold determined based on the number of ECUs 100 connected to network 300 (step S132).

When anomaly detector 11 determines that the cumulative time of the intervals between the transmissions of the ACL messages containing the same DN to network 300 is longer than the threshold determined based on the number of ECUs 100 connected to network 300 (Yes in step S132), anomaly detector 11 determines that there is an anomaly in network 300 (step S133). When anomaly detector 11 determines that the cumulative time of the intervals between the transmissions of the ACL messages containing the same DN to network 300 is less than or equal to the threshold determined based on the number of ECUs 100 connected to network 300 (No in step S132), anomaly detector 11 determines that there is no anomaly in network 300 (step S134).

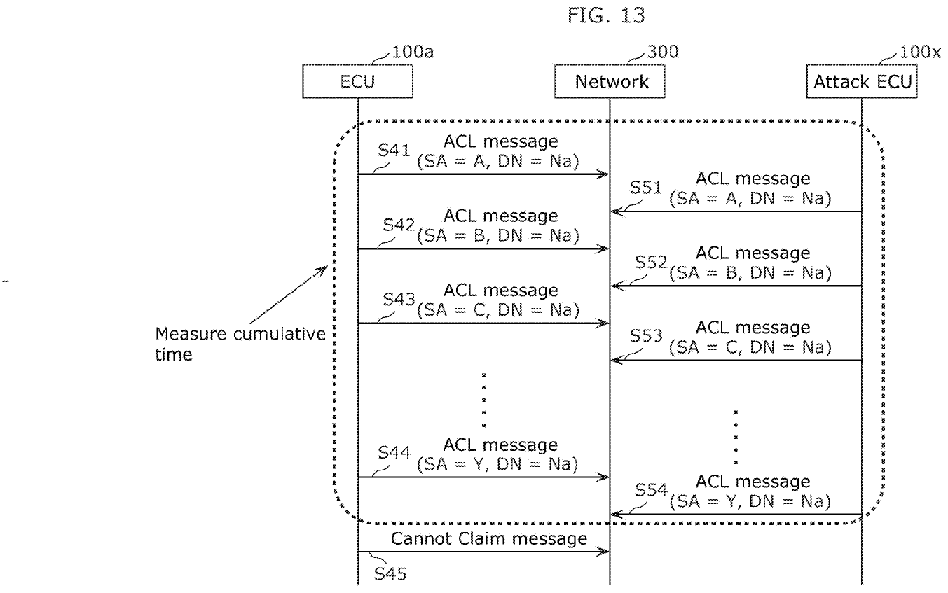

Here, the reason why anomaly detector 11 can determine that there is an anomaly in network 300 when the cumulative time of the intervals between the transmissions of the ACL messages containing the same DN to network 300 is longer than the threshold determined based on the number of ECUs 100 connected to network 300 will be described with reference to FIG. 13.

FIG. 13 is a diagram illustrating Example 2 of the method of detecting an anomaly in information processing apparatus 10 according to the embodiment.

For example, it is assumed that the DN of ECU 100a is greater than those of other ECUs 100b to 100g, in other words, among ECUs 100a to 100g, ECU 100a has the lowest priority to obtain the SA. At this time, examples of the situation in which ECU 100a transmits ACL messages for the longest time during the normal operation where there is no anomaly in network 300 include the following situation: ECU 100a transmits an ACL message, resulting in competition with one (for example, ECU 100b) of ECUs 100. ECU 100a transmits another ACL message containing a different SA, resulting in competition with ECU 100 (for example, ECU 100c) which did not compete with ECU 100a. ECU 100a then transmits another ACL message containing a different SA, resulting in competition with ECU 100 (for example, ECU 100d) which did not compete with ECU 100a. ECU 100a then transmits another ACL message containing a different SA, resulting in competition with ECU 100 (for example, ECU 100e) which did not compete with ECU 100a. ECU 100a then transmits another ACL message containing a different SA, resulting in ECU 100 (for example, ECU 100f) which did not compete with ECU 100a. ECU 100a then transmits another ACL message containing a different SA, resulting in competition with ECU 100 (for example, ECU 100g) which did not compete with ECU 100a. Finally, when there is no competitor ECU 100, ECU 100a transmits another ACL message containing a different SA, and successfully obtains the SA. In other words, transmission of ACL messages containing the same DN to network 300 beyond this number of times (here, 7 times) does not occur during normal operation. ECU 100a, which has transmitted an ACL message, waits for a reply to its own transmitted ACL message from another ECU 100 for at most a predetermined time (for example, 250 ms) since ECU 100 has transmitted a single ACL message. For example, when ECU 100a receives a reply from another ECU 100 having a DN smaller than its own DN within the predetermined time, ECU 100a transmits another ACL message containing a different SA without waiting until the predetermined time will have passed, and again, waits for a reply from another ECU 100 for at most the predetermined time. Accordingly, the interval between the transmissions of the ACL messages is at least the predetermined time or shorter. Thus, the number of transmissions of the ACL messages can be converted into the cumulative time of the intervals between the transmissions of the ACL messages to network 300. Thus, in this case above, the cumulative time of the intervals between the transmissions of ACL messages containing the same DN (for example, Na) to network 300 from the activation of the moving body is possibly the maximum cumulative time of the intervals between at most 7 transmissions of the ACL messages by ECU 100a (for example, 250 ms×7 times=1750 ms in maximum). In other words, during the normal operation, the cumulative time in the transmission of the ACL messages containing the same DN never exceeds this maximum cumulative time. Thus, the maximum cumulative time is defined as the threshold, and is compared to the cumulative time of the intervals between the transmissions of the ACL messages containing the same DN to network 300. The threshold can be determined based on the number of ECUs 100 connected to network 300, and specifically can be determined based on the number of ECUs 100 connected to network 300 (here, 7).

For example, in the case where attack ECU 100x is fraudulently connected to network 300 and tries to pretend to be ECU 100a, ACL messages containing the same DN, i.e., Na are transmitted from ECU 100a and attack ECU 100x, respectively, to network 300. In this case, as illustrated in FIG. 13, attack ECU 100x transmits an ACL message containing the same DN as that of ECU 100a every time when ECU 100a transmits an ACL message. As a result, the cumulative time of the intervals between the transmissions of the ACL messages containing the same DN to network 300 exceeds the threshold, which is the maximum cumulative time supposed during the normal operation.

For this reason, as represented by the dashed-lined frame in FIG. 13, anomaly detector 11 measures the cumulative time of the intervals between the transmissions of the ACL messages containing the same DN to network 300 from the activation of the moving body. When the cumulative time is longer than the time determined based on the number of ECUs 100 connected to network 300 (i.e., the maximum cumulative time), anomaly detector 11 can determine that there is an anomaly in network 300, and can detect an anomaly in network 300.

For example, the time determined based on the number of ECUs 100 connected to network 300 as the threshold may be preliminarily set by a user or a manager of information processing apparatus 10. Alternatively, information processing apparatus 10 may estimate the number of ECUs 100 connected to network 300 from the number of types of DN contained in the ACL messages transmitted to network 300, and may set the time determined based on the estimated number as the threshold.

The threshold determined based on the number of ECUs 100 connected to network 300 can be determined based on the time determined based on any other number than the number of ECUs 100 connected to network 300.

For example, in the case where another ECU 100 may be additionally connected to network 300 in the future, the threshold may be preliminarily increased by the number of ECUs 100 to be additionally connected. In this case, the threshold is the time determined based on the number of ECUs 100 which may be connected to network 300. For example, as the threshold, the time determined based on the number of ECUs 100 which may be connected to network 300 may be preliminarily set by a user or a manager of information processing apparatus 10.

In another case, for example, depending on the specification, a plurality of ECUs 100 connected to network 300 may include ECU 100 whose SA to use is preliminarily determined and set so as not to compete with others ECU 100 when ECU 100 obtains the SA. In this case, the threshold is the time based on the number of ECU 100 obtained by subtracting the number of ECUs 100 set so as not to compete with other ECUs 100 from the number of ECUs 100 connected to network 300. For example, as the threshold, the time determined based on the number of ECUs 100 obtained by subtracting the number of ECUs 100 set so as not to compete with other ECUs 100 from the number of ECUs 100 connected to network 300 may be preliminarily set by a user or a manager of information processing apparatus 10.

For example, a plurality of ECUs 100 connected to network 300 may include inactive ECUs 100. In this case, the threshold is the time determined based on the number of ECUs 100 obtained by subtracting the number of inactive ECUs 100 from the number of ECUs 100 connected to network 300. For example, as the threshold, the time determined based on the number of ECUs 100 obtained by subtracting the number of inactive ECUs 100 from the number of ECUs 100 connected to network 300 may be preliminarily set by a user or a manager of information processing apparatus 10. Alternatively, from the number of types of DN contained in the ACL messages transmitted to network 300, information processing apparatus 10 may estimate the number of ECUs 100 obtained by subtracting the number of inactive ECUs 100 from the number of ECUs 100 connected to network 300, and may set the time determined based on the estimated number as the threshold.

Thus, in Example 2 of the method of detecting an anomaly, the presence of an anomaly in network 300 can be detected when the cumulative time of the intervals between the transmissions of the ACL messages containing the same DN to network 300 is longer than the threshold determined based on the number of ECUs 100 connected to network 300.

### [Effects]

Information processing apparatus 10 is an information processing apparatus which detects an anomaly in network 300 to which a plurality of ECUs 100 is connected. Each of ECUs 100 is a device which transmits a declaration message claiming its SA to use in network 300 to network 300, and then starts transmission of a normal message containing the SA to network 300. The declaration message contains a unique DN preliminarily assigned to each ECU 100 which transmits the declaration message. Information processing apparatus 10 includes anomaly detector 11 which detects an anomaly in network 300 based on (i) the number of transmissions of declaration messages containing the same DN to network 300 or a cumulative time of intervals between the transmissions of declaration messages to network 300 and (ii) the number of ECUs 100 connected to network 300, and outputter 12 which outputs a result of detection.

In such a configuration, an anomaly in network 300 can be detected by comparing the number of transmissions of the declaration messages containing the same DN to network 300 or the cumulative time of the intervals between the transmissions of the declaration messages to network 300 with the number of ECUs 100 connected to network 300. In other words, communication for authentication and key exchange to detect an anomaly is not performed, and therefore a delay due to the communication does not occur. Moreover, because the normal message does not need to have the field for storing the MAC, the time needed to transmit such a normal message is not increased. Accordingly, information processing apparatus 10 can detect an anomaly in network 300 while suppressing degradation of communication quality.

Anomaly detector 11 may detect the presence of an anomaly in network 300 when the number of transmissions of the declaration messages containing the same DN to network 300 is greater than a threshold determined based on the number of ECUs 100 connected to network 300.

When there is no anomaly in network 300, the number of transmissions of the declaration messages containing the same DN to network 300 never exceeds the threshold determined based on the number of ECUs 100 connected to network 300. Accordingly, anomaly detector 11 can readily detect an anomaly in network 300 only by counting the number of transmissions of the declaration messages containing the same DN to network 300, and comparing the counted number to the threshold.

Anomaly detector 11 may detect the pretense of an anomaly in network 300 when the cumulative time of the intervals between the transmissions of the declaration messages containing the same DN to network 300 is longer than the threshold determined based on the number of ECUs 100 connected to network 300.

When there is no anomaly in network 300, the cumulative time of the intervals between the transmissions of the declaration messages containing the same DN to network 300 never exceeds the threshold determined based on the number of ECUs 100 connected to network 300. Accordingly, anomaly detector 11 can readily detect an anomaly in network 300 only by measuring the cumulative time of the intervals between the transmissions of the declaration messages containing the same DN to network 300, and comparing the measured cumulative time to the threshold.

Network 300 may be a CAN according to the SAE J1939 standards, and the declaration message may be an ACL message specified in the SAE J1939 standards.

Thus, the present disclosure can be used in the CAN according to the SAE J1939 standards.

Information processing system 1 includes information processing apparatus 10, a plurality of ECUs 100, and network 300.

Such a configuration can provide information processing system 1 which can detect an anomaly in network 300 while suppressing degradation of communication quality.

### Other Embodiments

As above, the embodiment has been described as an example of the technique according to the present disclosure. However, the technique according to the present disclosure is not limited to this, and can be used in embodiments appropriately subjected to modification, replacement, addition, omission, and the like. For example, one embodiment according to the present disclosure also covers modifications as follows.

For example, although information processing system 1 includes ECUs 100a to 100g in the description of the embodiment above, it is sufficient that information processing system 1 includes at least two ECUs 100.

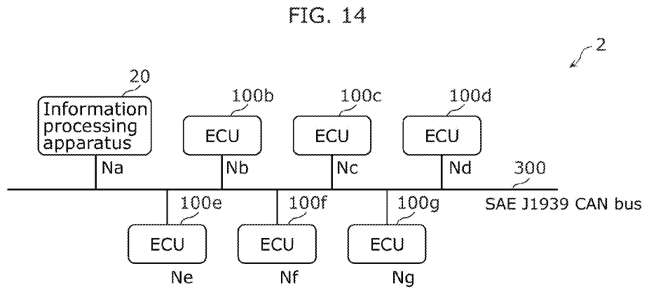

For example, although an example in which information processing system 1 includes information processing apparatus 10 which has a function to detect an anomaly in network 300 and is disposed separately from a plurality of ECUs 100 has been described in the embodiment above, any other configuration can be used. For example, the plurality of ECUs 100 each may include an information processing apparatus having the function to detect an anomaly in network 300. Such a configuration will be described with reference to FIG. 14.

FIG. 14 is a block diagram illustrating one example of information processing system 2 according to another embodiment.

As illustrated in FIG. 14, information processing apparatus 20 is one of ECUs 100. Here, ECU 100a described in the embodiment is information processing apparatus 20 also having the function to detect an anomaly in network 300.

Specifically, as ECU 100a, information processing apparatus 20 performs processing according to the content of the received message. Information processing apparatus 20 generates the normal message containing data indicating the states of the devices connected to information processing apparatus 20 or data such as an instruction value (control value), and periodically transmits the normal message to another ECU 100. As ECU 100a, information processing apparatus 20 transmits the declaration message to network 300, and then starts transmission of the normal message containing the SA to network 300. Furthermore, as information processing apparatus 10, information processing apparatus 20 includes anomaly detector 11 and outputter 12, and has a function to detect an anomaly in network 300.

Thus, information processing apparatus 20 is an information processing apparatus which detects an anomaly in network 300 to which a plurality of ECUs 100 is connected. Each of ECUs 100 is a device which transmits a declaration message claiming the SA to use in network 300 to network 300, and then starts transmission of the normal message containing the SA to network 300. The declaration message contains a unique DN preliminarily assigned to ECU 100 which transmits the declaration message. Information processing apparatus 20 is one of ECUs 100, and includes anomaly detector 11 which detects an anomaly in network 300 based on (i) the number of transmissions of the declaration messages containing the same DN to network 300 or the cumulative time of intervals between the transmissions of the declaration messages to network 300 and (ii) the number of ECUs 100 connected to network 300, and outputter 12 which outputs a result of detection.

As described above, information processing apparatus 20 having the function to detect an anomaly in network 300 may be one of ECUs 100.

It should be noted that the present disclosure can be implemented not only as an information processing apparatus and an information processing system but also as an information processing method including steps (processings) executed by the components which constitute the information processing apparatus.

For example, the steps in the information processing method may be executed by a computer (computer system). The present disclosure can be implemented as a program for causing the computer to execute the steps included in the information processing method.

The program is executed by the information processing apparatus which detects an anomaly in network 300 to which a plurality of ECUs 100 is connected. Each of ECUs 100 is a device which transmits a declaration message claiming an SA to use in network 300 to network 300, and then starts transmission of a normal message containing the SA to network 300. The declaration message contains a unique DN preliminarily assigned to ECU 100 which transmits the declaration message. As illustrated in FIG. 9, the program includes anomaly detection processing (step S111) of detecting an anomaly in network 300 based on (i) the number of transmissions of declaration messages containing the same DN to network 300 or a cumulative time of intervals between the transmissions of declaration messages containing the same DN to network 300 and (ii) the number of ECUs 100 connected to network 300, and output processing (step S112) of outputting a result of detection.

Furthermore, the present disclosure can be implemented as a non-transitory computer-readable recording medium, such as a CD-ROM having the program recorded thereon.

For example, in the case where the present disclosure is implemented by a program (software), the steps are executed by executing the program using hardware resources such as an CPU, a memory, and an input/output circuit of a computer. In other words, the steps are executed as follows: the CPU obtains data from a memory or an input/output circuit for computation, and outputs the computational result to the memory or the input/output circuit.

The components included in the information processing apparatus according to the embodiment may be implemented as a dedicated or general-purpose circuit.

Alternatively, the components included in the information processing apparatus according to the embodiment may be implemented as a large scale integration (LSI), which is an integrated circuit (IC).

The integrated circuit is not limited to the LSI, and may be implemented as a dedicated circuit or a general-purpose processor. A field programmable gate array (FPGA) or a reconfigurable processor enabling reconfiguration of connection and setting of circuit cells inside the LSI may be used.

Furthermore, if progress of the semiconductor technique or derivation of another technique therefrom leads to emergence of the integration technique which can replace the LSI, naturally, integration of the components included in the information processing apparatus may be performed using such a technique.

Besides, embodiments obtained from a variety of modifications of the embodiment conceived by persons skilled in the art and any combinations of the components and functions in the embodiments without departing the gist of the present disclosure are also included in the present disclosure.

While various embodiments have been described herein above, it is to be appreciated that various changes in form and detail may be made without departing from the spirit and scope of the present disclosure as presently or hereafter claimed.

Further Information about Technical Background to this Application

The disclosures of the following Japanese Patent Applications including specification, drawings and claims are incorporated herein by reference in their entirety: Japanese Patent Application No. 2020-006134 filed on Jan. 17, 2020.

### INDUSTRIAL APPLICABILITY

The present disclosure can be used in apparatuses and devices for treating with an anomaly in networks of trucks, buses, construction machines, tractors, trailers, or boats and ships, for example.

1. An information processing apparatus which detects an anomaly in a network to which electronic control units are connected,
each of the electronic control units being a device which transmits a declaration message claiming a source address to use in the network to the network, and starts transmission of a normal message containing the source address to the network,
the declaration message containing a device name which is unique to and preliminarily assigned to the device which transmits the declaration message,
the information processing apparatus comprising:
an anomaly detector which detects an anomaly in the network based on (i) a number of transmissions of declaration messages containing a same device name to the network or a cumulative time of intervals between the transmissions of the declaration messages containing the same device name to the network and (ii) a number of the electronic control units connected to the network; and
an outputter which outputs a result of detection.

2. The information processing apparatus according to claim 1,
wherein the anomaly detector detects an anomaly in the network when the number of transmissions of the declaration messages containing the same device name to the network is greater than a threshold determined based on the number of the electronic control units connected to the network.

3. The information processing apparatus according to claim 1,
wherein the anomaly detector detects an anomaly in the network when the cumulative time of the intervals between the transmissions of the declaration messages containing the same device name to the network is longer than a threshold determined based on the number of the electronic control units connected to the network.

4. The information processing apparatus according to claim 1,
wherein the network is a controller area network (CAN) according to Society of Automotive Engineers (SAE) 31939 standards, and
the declaration message is an address claim message specified in the SAE J1939 standards.

5. An information processing system, comprising:
the information processing apparatus according to claim 1;
the electronic control units; and
the network.

6. A non-transitory computer-readable recording medium for use in an information processing apparatus which detects an anomaly in a network to which electronic control units are connected, the non-transitory computer-readable recording medium having a program recorded thereon for causing the information processing apparatus to execute the program,
each of the electronic control units being a device which transmits a declaration message claiming a source address to use in the network to the network, and starts transmission of a normal message containing the source address to the network,
the declaration message containing a device name which is unique to and preliminarily assigned to the device which transmits the declaration message,
the program including:
detecting an anomaly in the network based on (i) a number of transmissions of declaration messages containing a same device name to the network or a cumulative time of intervals between the transmissions of the declaration messages containing the same device name to the network and (ii) a number of the electronic control units connected to the network; and
outputting a result of detection.

7. An information processing apparatus which detects an anomaly in a network to which electronic control units are connected,
each of the electronic control units being a device which transmits a declaration message claiming a source address to use in the network to the network, and starts transmission of a normal message containing the source address to the network,
the declaration message containing a device name which is unique to and preliminarily assigned to the device which transmits the declaration message,
wherein the information processing apparatus is one electronic control unit among the electronic control units, and
the information processing apparatus comprises:
an anomaly detector which detects an anomaly in the network based on (i) a number of transmissions of declaration messages containing a same device name to the network or a cumulative time of intervals between the transmissions of the declaration messages containing the same device name to the network and (ii) a number of the electronic control units connected to the network; and
an outputter which outputs a result of detection.
